(19) United States
(12) Patent Application Publication
(10) Pub. No.: US 2016/0332101 A1
(43) Pub. Date: Nov. 17, 2016

(54) Filter including Spring Tube Bypass Assembly

(71) Applicant: CUMMINS FILTRATION IP, INC., Columbus, IN (US)

(72) Inventors: Walter BOOKER, Cookeville, TN (US); Charles W. HAWKINS, Sparta, TN (US); Ismail BAGCI, Cookeville, TN (US)

(73) Assignee: CUMMINS FILTRATION IP, INC, Columbus, IN (US)

(21) Appl. No.: 15/112,564

(22) PCT Filed: Jan. 22, 2015
(86) PCT No.: PCT/US2015/012429

§ 371 Date: Jul. 19, 2016

Related U.S. Application Data
(60) Provisional application No. 61/931,382, filed on Jan. 24, 2014.

(51) Int. Cl. B01D 35/147

(52) U.S. Cl. CPC B01D 35/147; B01D 2201/291; B01D 2201/0461; B01D 2201/4038; B01D 2201/0415; B01D 2201/16; B01D 2201/4084

(57) ABSTRACT

A filter cartridge including a filter media, a first end plate including a bypass flow opening, a second end plate, and a spring tube bypass assembly. The spring tube bypass assembly includes a first center tube and a spring. The spring tube bypass assembly is configured such that fluid flow through the bypass flow opening is blocked when a fluid pressure acting on the filter cartridge is below a predetermined pressure and fluid may flow through the bypass filter opening when the fluid pressure acting on the filter cartridge exceeds the predetermined pressure.

CROSS-REFERENCE TO RELATED PATENT APPLICATIONS

This application claims priority to and the benefit of U.S. Provisional Patent Application No. 61/931,382, filed Jan. 24, 2014, the entire disclosure of which is incorporated herein by reference.

### TECHNICAL FIELD

The present application relates to a fluid filter cartridge.

### BACKGROUND

In many applications, it is desirable to have a filter cartridge including a bypass valve. The bypass valve may allow unfiltered fluid to bypass the filter media of the filter cartridge in situations where the unfiltered fluid pressure exceeds a predetermined level.

### SUMMARY

Various embodiments relate to a filter cartridge including a filter media, a first end plate including a bypass flow opening, a second end plate, and a spring tube bypass assembly. The spring tube bypass assembly may include a first center tube and a spring, and the spring tube bypass assembly may be configured such that fluid flow through the first bypass flow opening is blocked when a fluid pressure acting on the filter cartridge is below a predetermined pressure and fluid may flow through the bypass filter opening when the fluid pressure acting on the filter cartridge exceeds the predetermined pressure.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a cross-section view of a filter cartridge according to one application.

FIG. 2 is perspective view of the cross-section depicted in FIG. 1.

FIG. 3 is an exploded of the filter cartridge of FIG. 1.

FIG. 4 is a cross-section of a portion of a filter cartridge of the type shown in FIG. 1 with the bypass valve in an open state.

FIG. 5 is perspective view of a spring tube bypass assembly according to one application.

FIG. 6 is a perspective view of a first portion of a center tube according to one application.

FIG. 7 is a perspective view of a partially assembled spring tube bypass assembly according to one application.

FIG. 8 is an exploded view of a spring tube bypass assembly according to one application.

FIG. 9 is a detailed view of the spring tube bypass assembly of FIG. 8 in an assembled state.

FIG. 10 a detailed view of the spring tube bypass assembly of FIG. 8 in an unassembled state.

FIG. 11 is a perspective view of the spring tube bypass assembly of FIG. 8.

FIG. 12 is a perspective view of the spring tube bypass assembly of FIG. 8 in a partially assembled state.

FIG. 13 is a perspective view of the spring tube bypass assembly of FIG. 8 in a partially assembled state.

FIG. 14 is a perspective view of the spring tube bypass assembly of FIG. 8 in a partially assembled state.

FIG. 15 is a perspective view of a center tube according to one application.

FIG. 16 is detailed view of a portion of the center tube of FIG. 15.

FIG. 17 is a cross-section view of a portion of a spring tube bypass assembly according to one application.

FIG. 18 is a cross-section view of a portion of a spring tube bypass assembly according to one application.

FIG. 19 is a cross-section view of a portion of a spring tube bypass assembly according to one application.

FIG. 20 is a cross-section view of a portion of a spring tube bypass assembly according to one application.

FIG. 21 is a cross-section view of a filter cartridge according to one application.

FIG. 22 is a perspective view of a portion of the cross-section depicted in FIG. 21.

FIG. 23 is a perspective view of the filter cartridge depicted in FIG. 21.

FIG. 24 is cross-section view of the filter cartridge depicted in FIG. 21 with the bypass valve in a closed position.

FIG. 25 is cross-section view of the filter cartridge depicted in FIG. 21 with the bypass valve in an open position.

FIG. 26 is a perspective view of a portion of the cross-section depicted in FIG. 25.

FIG. 27 is a cross-section view of a filter cartridge according to one application.

### DETAILED DESCRIPTION

Various embodiments relate to a fluid filter cartridge, for example a fuel filter cartridge, including a filter media and a spring tube bypass assembly. The filter cartridge may be employed in any appropriate fluid filter system, for example a vehicle or engine application. According to one embodiment, the filter cartridge may be employed in a diesel engine application.

According to one embodiment, the filter cartridge may include a bypass functionality. The bypass functionality allows fluid to bypass the filter media of the filter cartridge when the fluid pressure acting on the filter cartridge exceeds a predetermined level. Fluid pressure acting on the filter cartridge may be elevated when the downstream demand for filtered fluid is greater than the amount of fluid passing through the filter media. An increase in fluid pressure may be the result of a temporary increase in the downstream demand for filtered fluid, for example during cold startup of a diesel engine. In other circumstances, an increase in fluid pressure may be the result of a decreased flow capacity of the filter media, for example the filter media may be clogged by dirt or other contaminants.

The spring tube bypass assembly is in a closed position when the fluid pressure acting on the filter cartridge is below the predetermined pressure, and fluid is prevented from flowing through the bypass filter openings and into the spring tube bypass assembly. In the case that the fluid pressure acting on the filter cartridge exceeds the predetermined pressure, the spring tube bypass assembly is in an open position, and fluid may flow through the bypass filter openings and into the spring tube bypass assembly without passing through the filter media. The predetermined pressure may be referred to as a “cracking” pressure. The pressure at which the bypass tube assembly allows the flow of fluid is dependent on the spring constant of the spring employed and the surface area of the valve element on which the fluid pressure may act. In the case that the fluid pressure acting on the filter cartridge is reduced below the predetermined pressure while the spring tube bypass assembly is in the open state, the spring tube bypass assembly returns to the closed state.

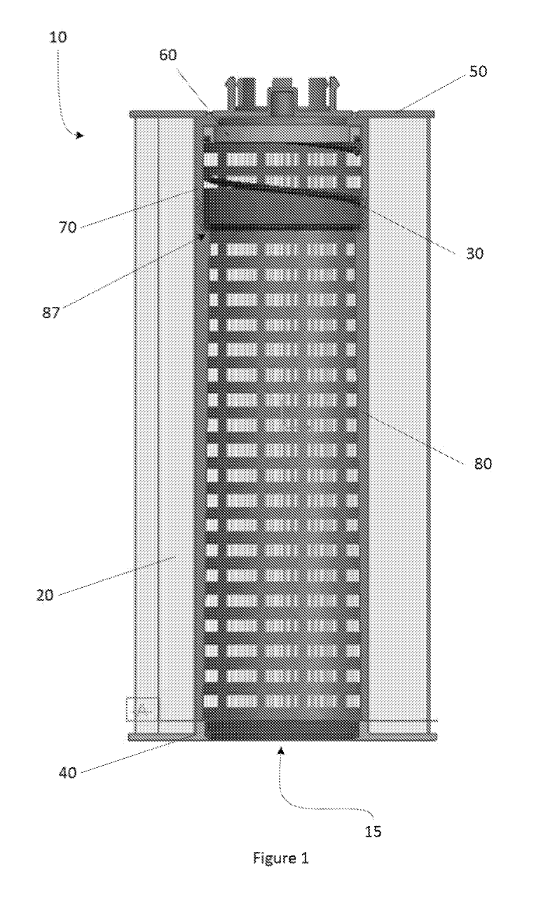

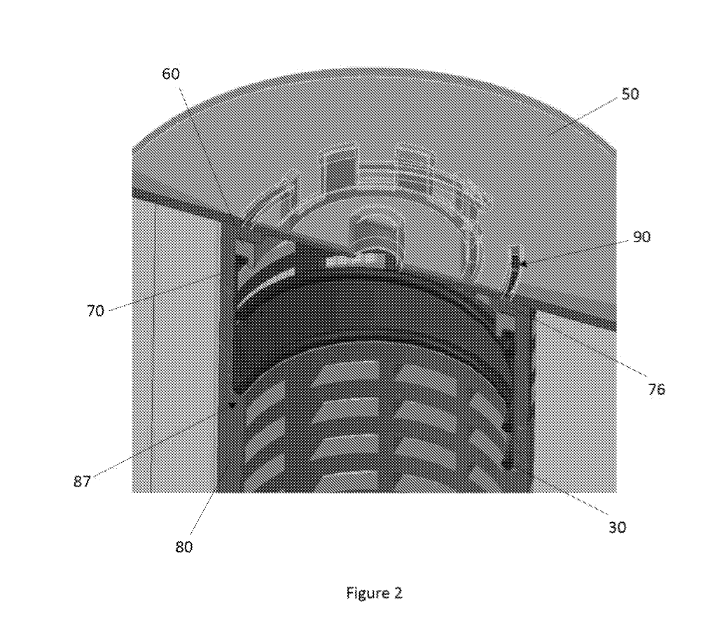

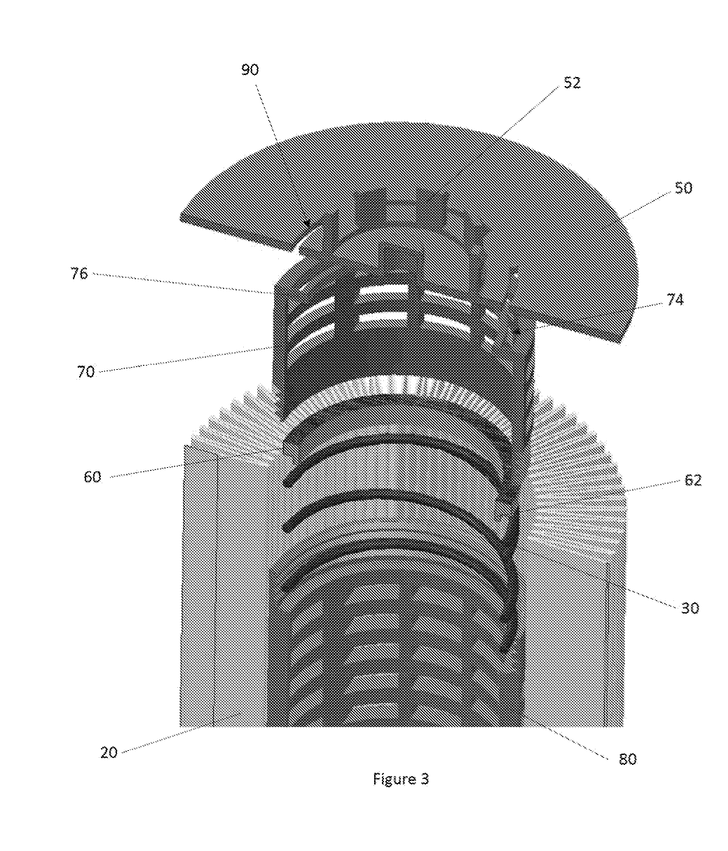

As illustrated in FIGS. 1-4, the filter cartridge 10 may include a first end plate 50, a filter media 20, a second end plate 40 and a spring tube bypass assembly. The first end plate 50 includes at least one bypass flow opening 90. The first end plate 50 may include any appropriate number of bypass flow openings 90. In one embodiment, the first end plate 50 includes a plurality of bypass flow openings 90. In another embodiment, the first end plate 50 includes four bypass flow openings 90.

The spring tube bypass assembly includes a first center tube 80, a second center tube 70, and a spring 30. The second center tube 70 includes a spring support flange 76 extending radially on the interior of the second center tube, and the first center tube 80 includes a first spring support flange 87. The spring support flanges may have any appropriate geometry. According to one embodiment, the first spring support flange is formed by a narrowing of the first center tube 80. The second spring support flange may be formed by a projection 76 extending radially from the inner surface of the second center tube 70.

The second spring support flange 76 includes at least one fluid flow opening 74. The second spring support flange 76 may include any appropriate number of fluid flow openings 74. The fluid flow openings 74 are configured to receive fluid that flows through the bypass flow openings 90 in the first end plate 50. In one embodiment, the number of fluid flow openings 74 is the same as the number of bypass flow openings 90. The geometry of the fluid flow openings 74 may be substantially the same as, or the same as, the bypass flow openings 90. In another embodiment, the geometry of the bypass flow openings 90 and the fluid flow openings 74 is such that sufficient overlap between the openings is produced to allow fluid to flow from the bypass openings 90 to the fluid flow openings 74 at any relative rotation of the second center tube 70 relative to the first end plate 50.

A valve element 60 is disposed between the spring 30 and the second spring support flange 76. The valve element 60 is biased against the second spring support flange 76 by the spring. The valve element 60 is configured to prevent fluid flow from the fluid flow openings 74 to the interior of the second center tube 70 when the spring tube bypass assembly is in the closed position. The valve element 60 may have any appropriate geometry. In one embodiment, the valve element 60 is in the form of a ring with a flat surface that bears against the second spring support flange 76 when the spring tube bypass assembly is in the closed position. The valve element 60 may include a projection 62 on the surface of the valve element adjacent the spring 30. The projection 62 is configured to locate the valve element 60 with respect to the spring 30.

The spring 30 is located on the interior of the first center tube 80 and the second center tube 70. In one embodiment, the spring 30 is a coil spring. However, it should be understood that other types of springs or biasing members may be used in particular arrangements based upon design and operational considerations. Contact between the spring 30 and the filter media 20 is prevented by the first center tube and the second center tube. This arrangement prevents wear on the filter media 20 as a result of the action of the spring 30.

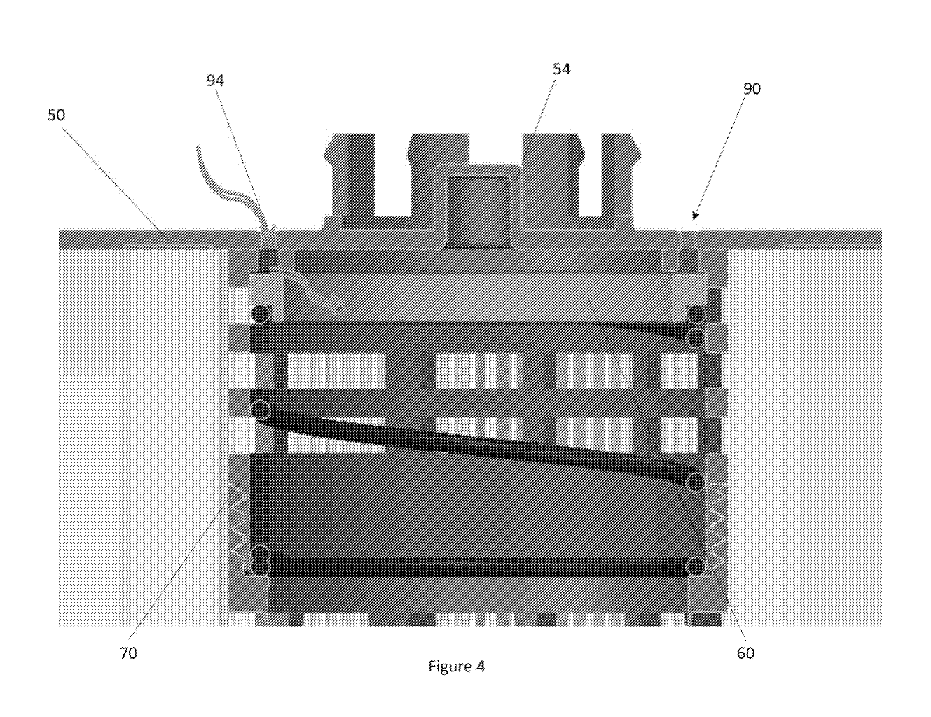

FIG. 4 depicts the spring tube bypass assembly in an open state. The fluid pressure acting on the filter cartridge 10 exceeds the predetermined pressure, and forces the valve element 60 to move away from the second spring support flange 76. The resultant gap between the valve element 60 and the second spring support flange 76 allows fluid 94 to flow through bypass openings 90 into the interior of the second center tube 70. The path of the fluid 94 passes through bypass openings 90 and fluid flow openings 74 before reaching the interior of the second center tube 70. The fluid 94 does not pass through the filter media 20 before reaching the interior of the second center tube.

The second end plate 40 includes fluid outlet 15. The sizes of the components of the spring tube bypass assembly are such that the components are not capable of passing through the fluid outlet 15. This relationship prevents components of the spring tube bypass assembly from flowing out of the filter cartridge 10 and reaching downstream elements. Damage may occur to downstream elements if components of the spring tube bypass assembly reach downstream components, resulting in downtime or repair costs. By preventing downstream damage as a result of spring tube bypass components, manufacturer warranty, repair costs and downtime may be minimized.

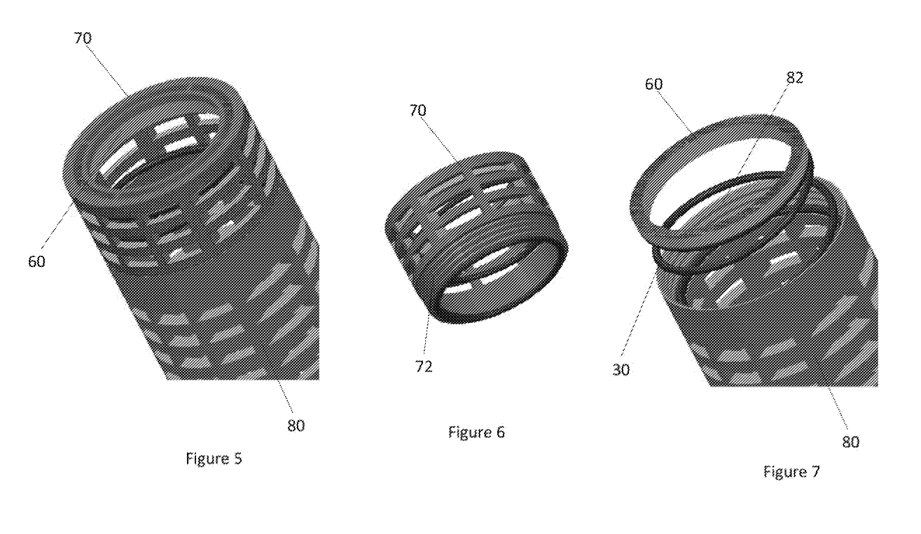

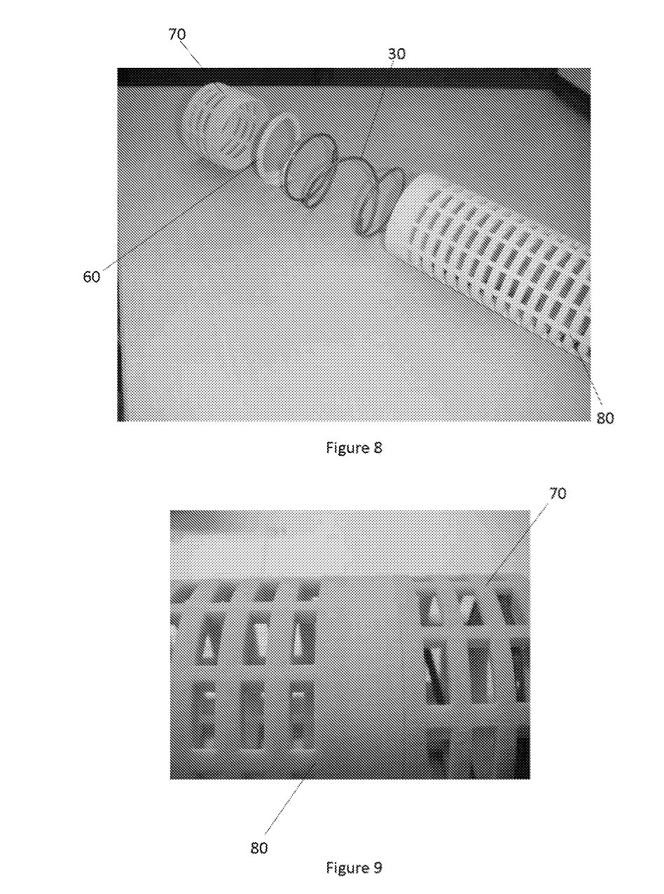

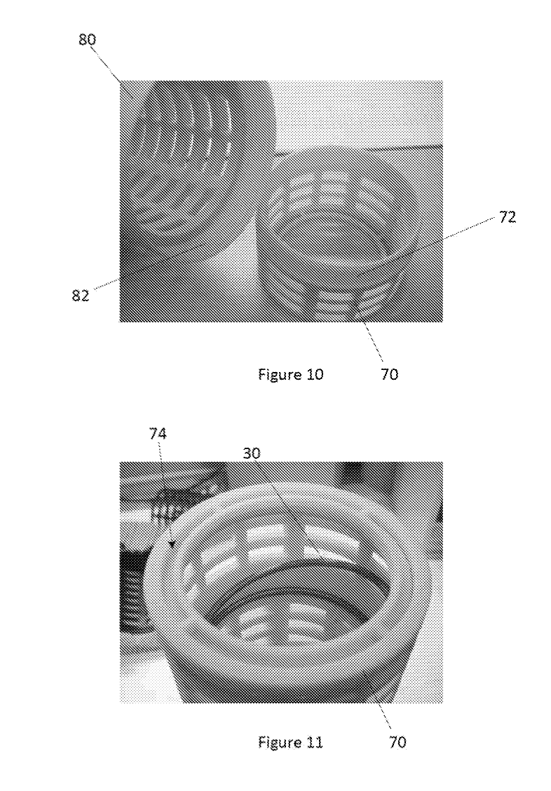

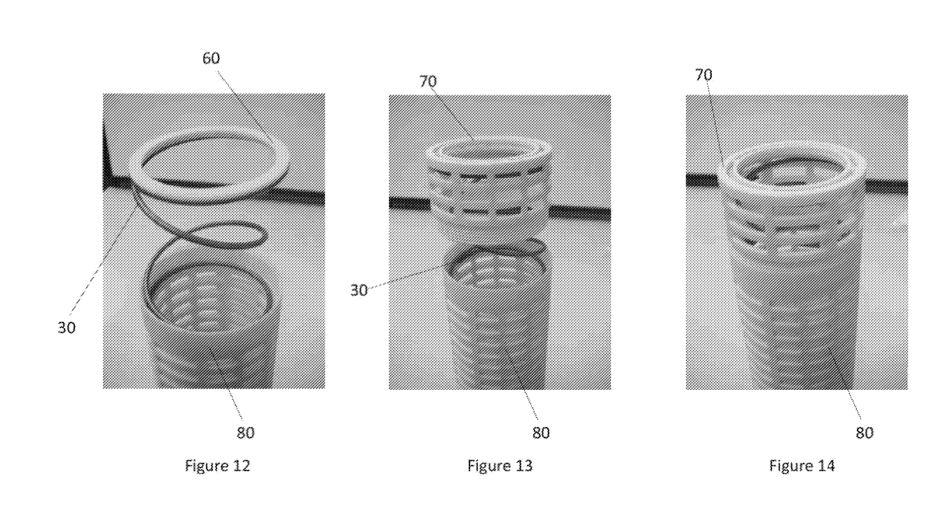

The spring tube bypass assembly does not require any specialized procedures, equipment or tools to assemble. This allows the spring tube bypass assembly to be entirely assembled on the same manufacturing line as the remainder of the filter cartridge, reducing production costs and time. As illustrated in FIGS. 5-14, the spring 30 is placed in the first center tube 80, the valve element 60 is placed on the spring 30, and the second center tube 70 is placed over the spring 30 and valve element. The first center tube 80 and the second center tube 70 are then attached. This arrangement produces a self-contained spring tube bypass assembly as shown in FIG. 14. The self-contained spring tube bypass assembly provides the benefit of not exerting any external forces on other components of the filter system during assembly, allowing for increased ease of assembly and increasing manufacturing flexibility by enabling off-line pre-assembly of the spring tube bypass assembly.

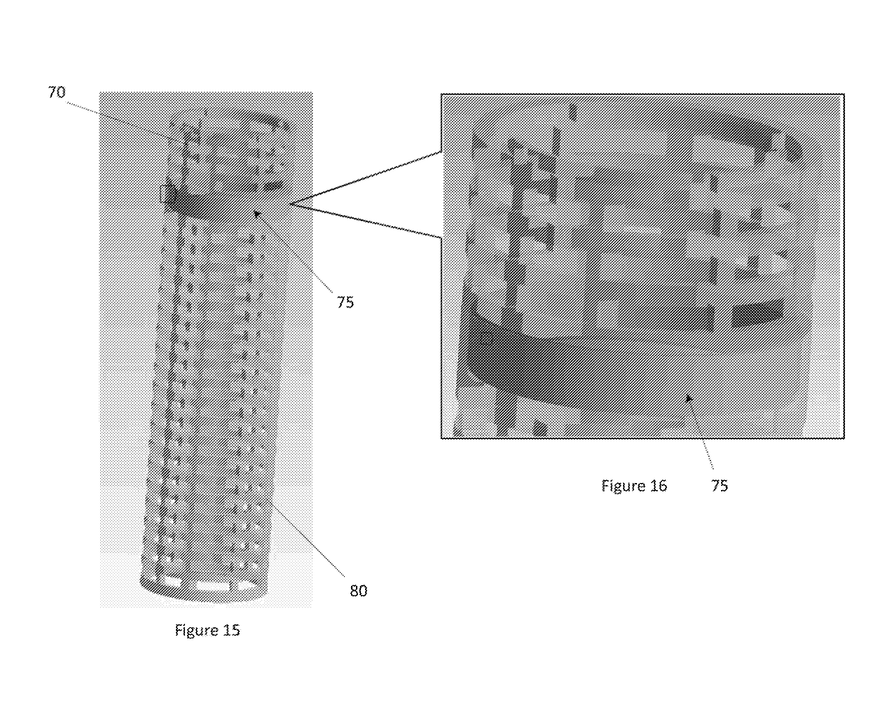

The attachment of the first center tube 80 and the second center tube 70 may be achieved by any suitable attachment mechanism. In one embodiment, the first center tube 80 is attached to the second center tube 70 by a threaded attachment. As illustrated in FIGS. 5-14, the first center tube 80 includes internal threads 82 that are configured to engage the external threads 72 of the second center tube 70. According to another embodiment, the first center tube 80 may be attached to the second center tube 70 by an adhesive bond 75. As illustrated in FIGS. 15-16, the adhesive bond 75 is formed between overlapping portions of the first center tube 80 and the second center tube 70.

The first center tube 80 and the second center tube 70 are attached such that the spring 30 is in a constant state of compression. The compression of the spring 30 between the first spring support flange 87 and the second spring support flange 76 biases the valve element against the second spring support flange 76 when the spring tube bypass assembly is in a closed state.

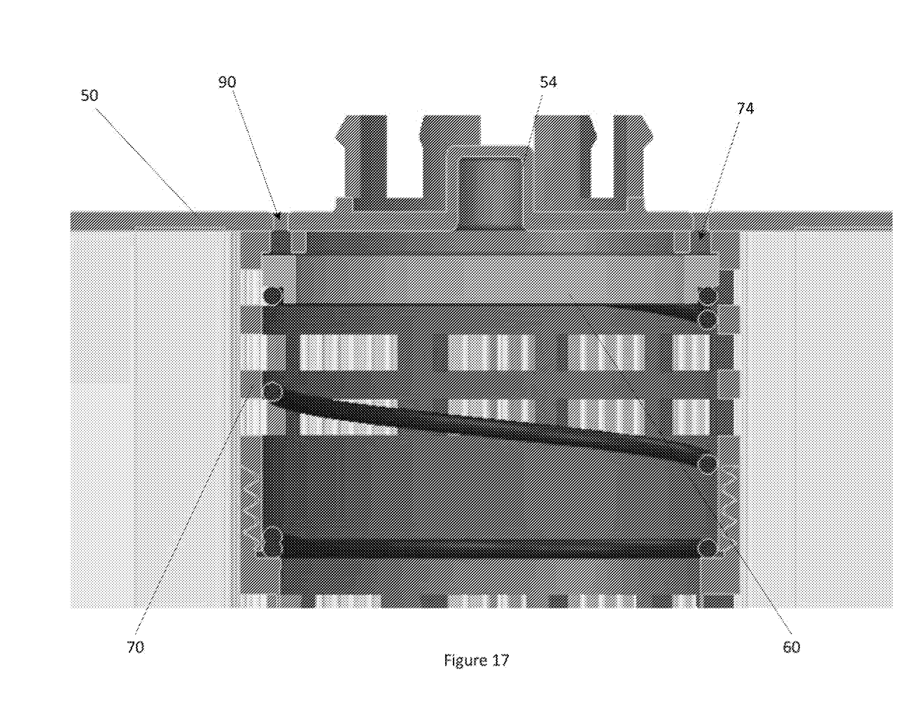

The second center tube 70 may be attached to the first end plate 50. The attachment of the second center tube 70 and the first end plate 50 may be achieved by any suitable attachment mechanism. As illustrated in FIG. 17, the second center tube 70 is embedded in the first end plate 50. The embedded connection is produced by heating at least the attachment portion of the first end plate 50 above its melting point. The second center tube 70 is then forced into the first end plate 50 to a distance of less than about 1 mm. After cooling, the first end plate 50 and the second center tube 70 are “fused” together and physically attached. The first end plate also includes projections 52 configured to connect the filter cartridge 10 to a filter system. The first end plate 50 may include a receiving projection 54 configured to accommodate additional components of a filter system. Similarly, the first center tube 80 and the second end plate 40 may be attached by any suitable mechanism.

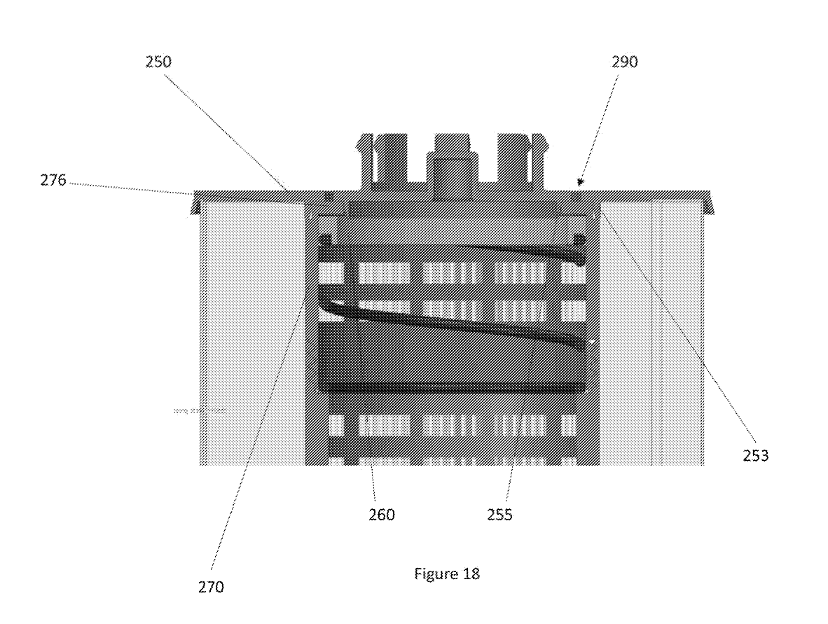

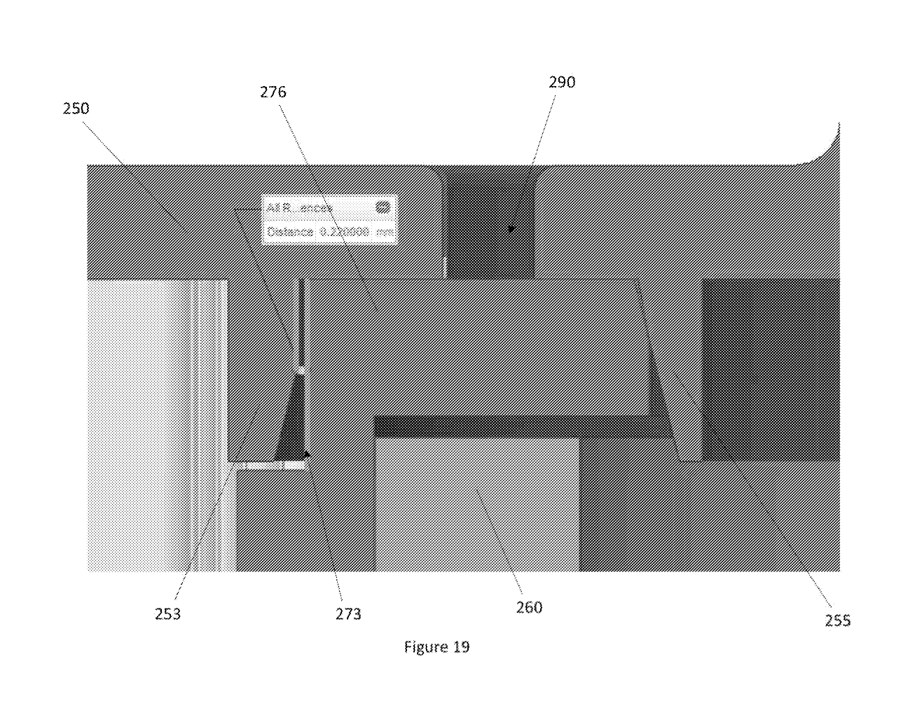

According to another embodiment, the first end plate 250 may include protrusions configured to locate the spring tube bypass assembly relative to the first end plate. As shown in FIG. 18, the first end plate 50 includes outer protrusion 253 and inner protrusion 255. The outer protrusion 253 is configured to substantially match the outside diameter of an end of the second center tube 270. The inner protrusion 255 is configured to substantially match the interior diameter of the second spring support flange 276. This arrangement ensures that the second spring support flange 276 and the valve element 260 are aligned with the bypass flow openings 290 of the first end plate 250. As illustrated in FIG. 19, the surfaces of the outer protrusion 253 and inner protrusion 255 facing each other include an inclined surface such that the distance between the surfaces of the protrusions narrows in the direction of the first end plate 250. The surfaces of the second spring support flange 276 may be configured such that when the second spring support flange 276 comes in to contact with the protrusions 253, 255 the second spring support flange 276 is guided to the appropriate location in relation to the first end plate 250. The second center tube 270 may include an indentation 273 adjacent to the second spring support flange 276. The indentation 273 is configured to accept the outer protrusion 253 of the first end plate 250. According to another embodiment, the surfaces of the outer protrusion 253 and inner protrusion 255 facing each other may be individually selected to be substantially parallel to the central axis of the filter cartridge. The attachment between the second spring support flange 276 and the first end plate 250 may additionally include an adhesive. In one embodiment, an epoxy is disposed between the second spring support flange 276 and the first end plate 250.

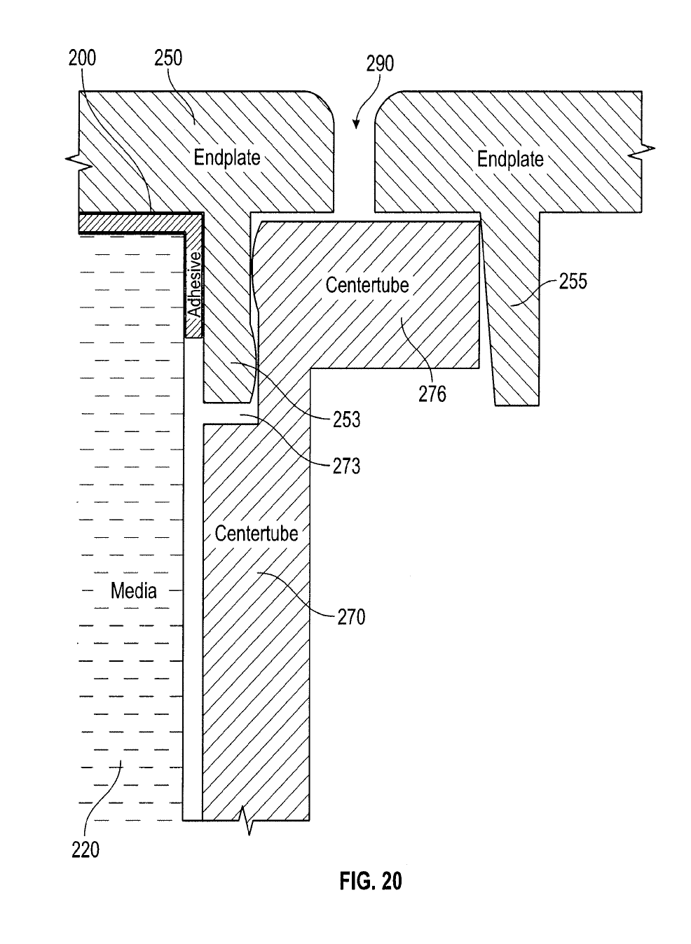

According to another embodiment, the second center tube 270 is attached to the first end plate 250 by a press fit attachment mechanism. As shown in FIG. 20, the outer protrusion 253 and the surface of the second spring support flange 276 facing the outer protrusion 253 include enlarged areas configured to lock the second center tube 270 in place between the outer protrusion 253 and the inner protrusion 255. The inclined surface of the inner protrusion 255 faces the outer protrusion 253 such that the distance between the surfaces of the protrusions narrows in the direction of the first end plate 250, forcing the second spring support flange 276 in to contact with the outer protrusion 253, locking the second center tube 270 in location relative to the first end plate 250. The filter media 220 may be sealed to the first end plate 250 by the use of an adhesive material 200.

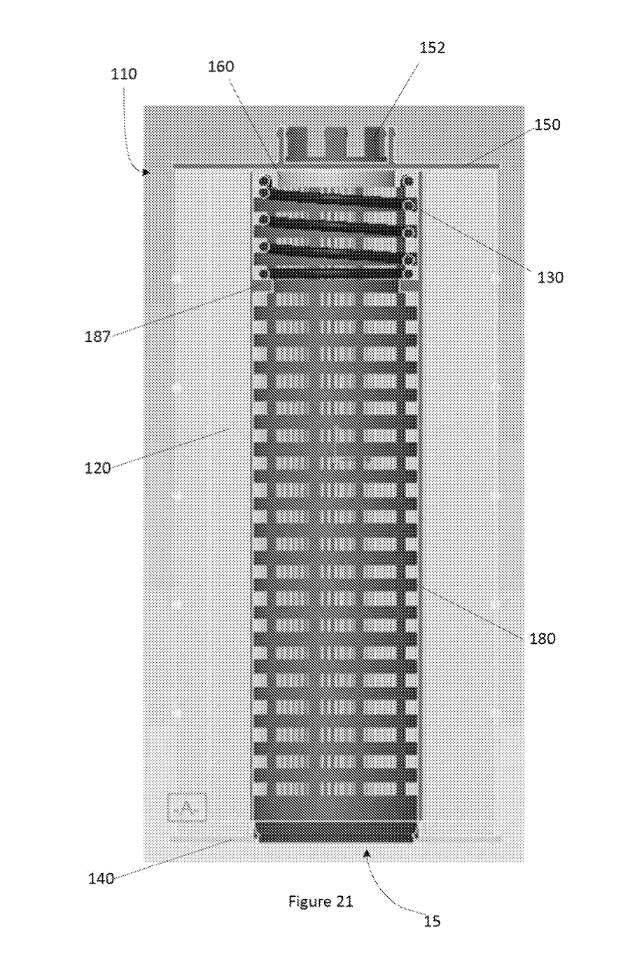

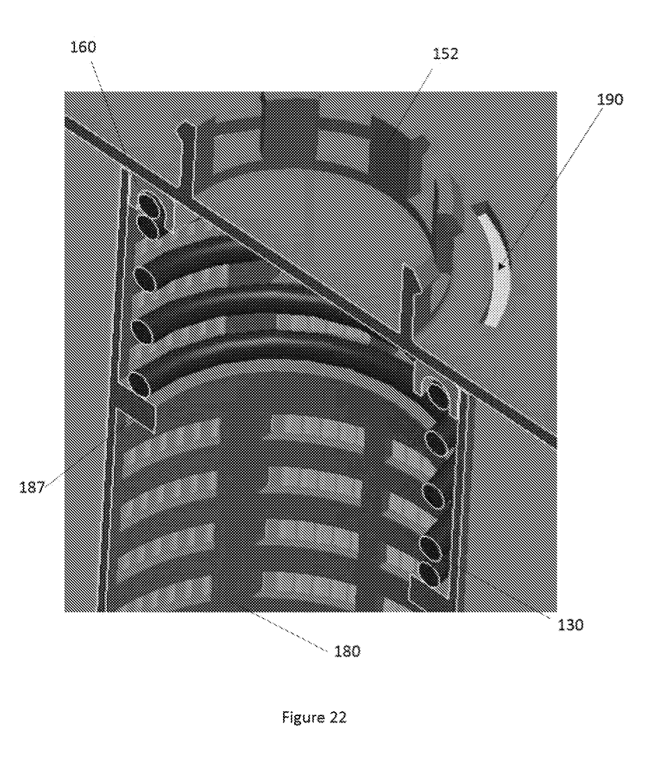

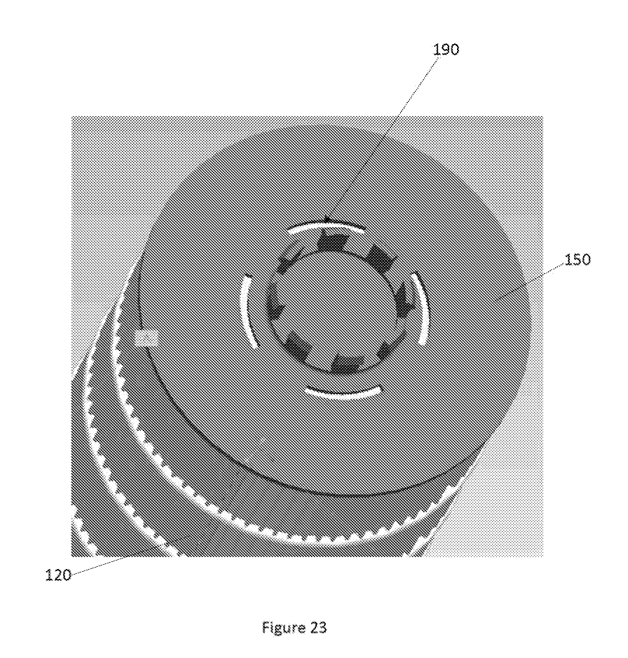

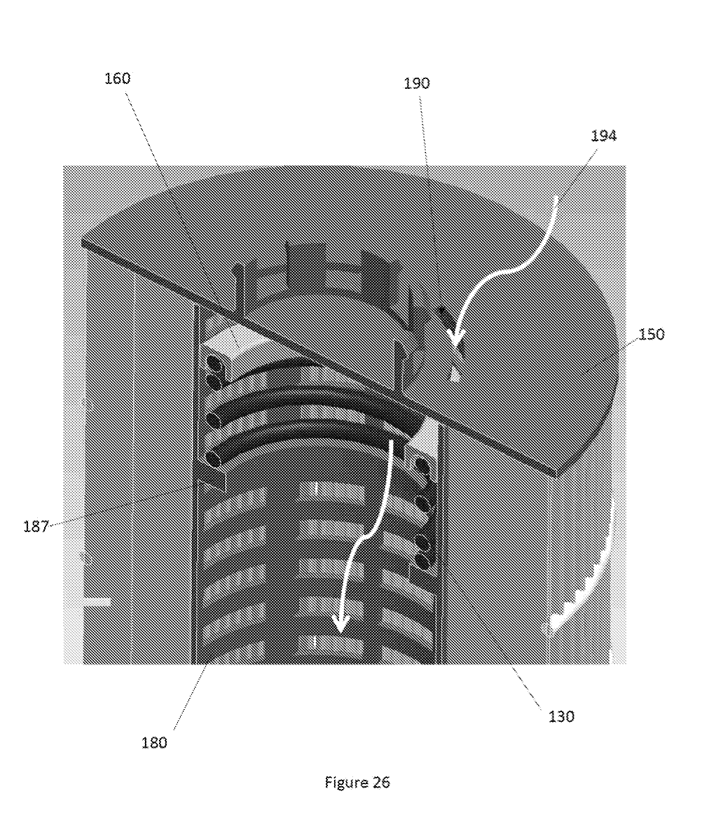

As illustrated in FIGS. 21-26, the filter cartridge 110 may include a first end plate 150, a filter media 120, a second end plate 140 and a spring tube bypass assembly. The first end plate 150 includes at least one bypass flow opening 190. The first end plate 150 may include any appropriate number of bypass flow openings 190. In one embodiment, the first end plate 150 includes a plurality of bypass flow openings 190. In another embodiment, the first end plate 140 includes four bypass flow openings 190.

The spring tube bypass assembly includes a first center tube 180, a valve element 160 and a spring 130. The first center tube 180 includes a first spring support flange 187 extending radially on the interior of the first center tube 180. The spring support flange may have any appropriate geometry. According to one embodiment, the first spring support flange is formed by a projection 187 extending radially from the inner surface of the first center tube 180.

The valve element 160 is disposed between the spring 130 and the first end plate 150. The valve element 160 is biased against the first end plate 150 by the spring 130. The valve element 160 is configured to prevent fluid flow from the bypass flow openings 190 to the interior of the first center tube 180 when the spring tube bypass assembly is in the closed position. The valve element 160 may have any appropriate geometry. In one embodiment, the valve element 160 is in the form of a ring with a flat surface that bears against the first end plate 150 when the spring tube bypass assembly is in the closed position. The valve element 160 may include a channel on the surface of the valve element adjacent the spring 130. The channel is configured to locate the valve element 160 with respect to the spring 130, and may have a u-shaped cross-section.

The spring 130 is located on the interior of the first center tube 180. The spring 130 may be any appropriate spring. In one embodiment, the spring 130 is a coil spring. Contact between the spring 130 and the filter media 20 is prevented by the first center tube 180. This arrangement prevents wear on the filter media 120 as a result of the action of the spring 130.

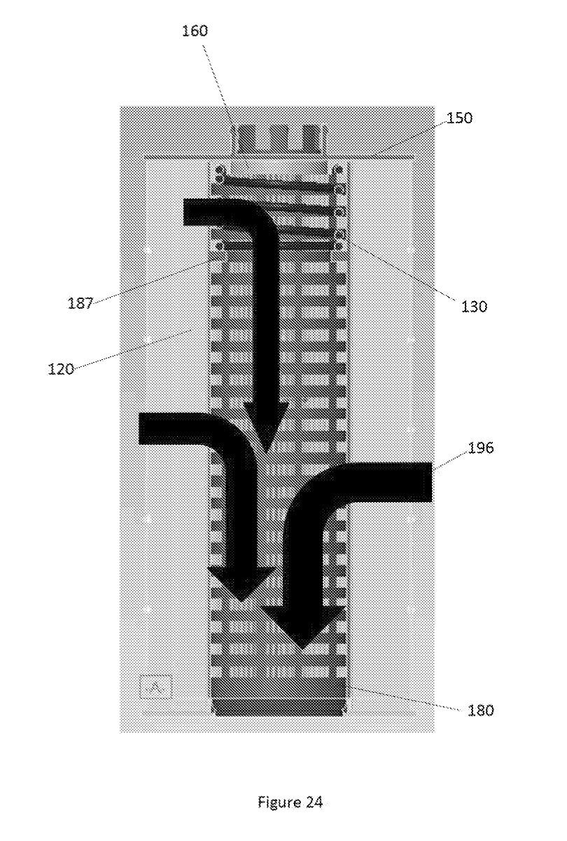

FIG. 24 depicts the spring tube bypass assembly in a closed state. The fluid pressure acting on the filter cartridge 110 is below the predetermined pressure, and the valve element 160 is forced in to contact with the first end plate 150 by the spring 130. The valve element 160 prevents fluid flow through bypass flow openings 190. The fluid 196 that enters the interior of the first center tube first passes through the filter media 120.

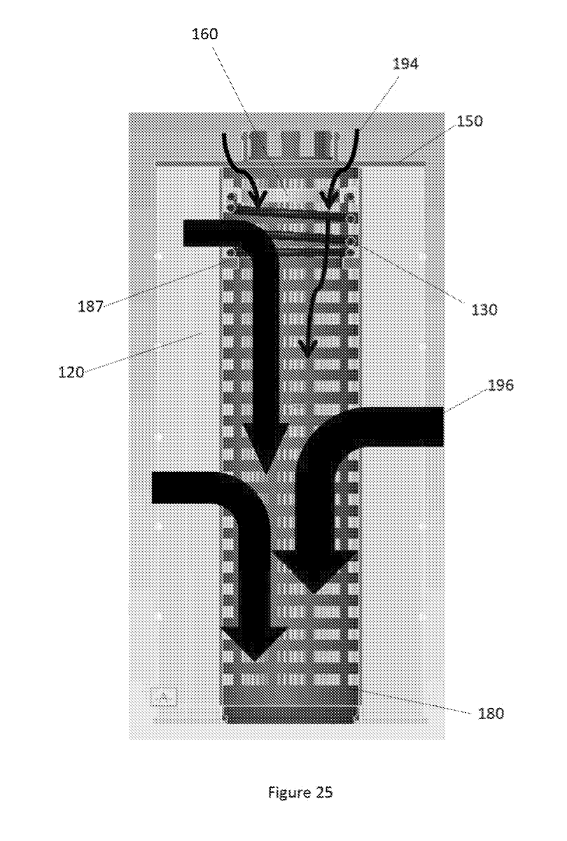

FIG. 25 depicts the spring tube bypass assembly in an open state. The fluid pressure acting on the filter cartridge 110 exceeds the predetermined pressure, and forces the valve element 160 to move away from the first end plate 150. The resultant gap between the valve element 160 and the first end plate 150 allows fluid 194 to flow through bypass openings 190 into the interior of the first center tube 180 in addition to the fluid 196 that enters the interior of the first center tube 180 by passing through the filter media 120. The fluid 194 does not pass through the filter media 120 before reaching the interior of the first center tube 180.

The second end plate 140 includes fluid outlet 115. The sizes of the components of the spring tube bypass assembly are such that the components are not capable of passing through the fluid outlet 115. This relationship prevents components of the spring tube bypass assembly from flowing out of the filter cartridge 110 and reaching downstream elements. Damage may occur to downstream elements if components of the spring tube bypass assembly reach downstream components, resulting in downtime or repair costs. By preventing downstream damage as a result of spring tube bypass components, manufacturer warranty costs, repair costs and downtime may be minimized.

The first center tube 180 and the first end plate 150 are configured such that the spring 130 is in a constant state of compression. The compression of the spring 130 between the first spring support flange 187 and the first end plate 150 biases the valve element 160 against the first end plate when the spring tube bypass assembly is in a closed state.

The first center tube 180 and the first end plate 150 may be attached in a manner similar to attachment between the second center tube 70 and the first end plate 50. Similarly, the first center tube 180 and the second end plate 140 may be attached.

The first end plate 150 may include projections 152 configured to connect the filter cartridge 110 to a filter system.

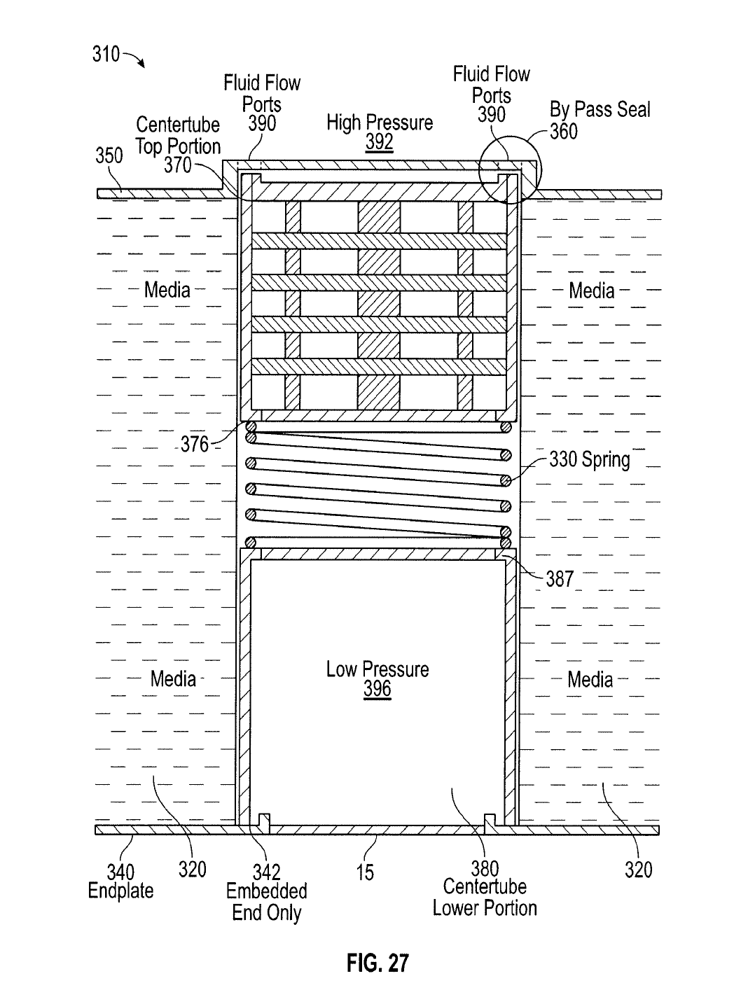

As illustrated in FIG. 27, the filter cartridge 310 may include a first end plate 350, a filter media 320, a second end plate 340 and a spring tube bypass assembly. The first end plate 350 includes at least one bypass flow opening 390. The first end plate 350 may include any appropriate number of bypass flow openings 390. In one embodiment, the first end plate 350 includes a plurality of bypass flow openings 390.

The spring tube bypass assembly includes a first center tube 380, a second center tube 370, and a spring 330. The first center tube 380 includes a first spring support flange 387 extending radially on the interior of the first center tube 380. The second spring support flange 387 is located at an end of the first center tube 380 adjacent to the spring 330. The second center tube 370 includes a second spring support flange 376 extending radially on the interior of the second center tube 370. The second spring support flange 376 is located at an end of the second center tube 370 adjacent to the spring 330. The spring support flanges may have any appropriate geometry. The spring support flanges may be formed by a projection 387, 376 extending radially from the inner surface of the center tubes 380, 370.

The first center tube 380, spring 330 and second center tube 370 are arranged in series along the central axis of the filter cartridge between the first end plate 350 and the second end plate 340. The first center tube 380 may be embedded 342 in the second end plate 340. The first end plate is configured to accept an end of the second center tube 370 opposite from the second spring flange 376. The end of the second center tube 370 that engages the first end plate 350 forms a valve element 360 that seals the bypass flow openings 390. The spring 330 is compressed between the first spring support flange 387 and the second spring support flange 376 when the spring tube bypass assembly is fully assembled. This arrangement biases the second center tube 370 against the first end plate 350 such that the valve element 360 seals the bypass flow openings when the spring tube bypass assembly is in a closed position.

The fluid pressure 392 acting on the filter cartridge 310 is high in comparison to the low pressure 396 of the fluid within the first center tube 380. In the case that the fluid pressure acting on the filter cartridge 310 exceeds the predetermined pressure, the spring 330 is compressed by the fluid pressure acting on the valve element 360 and the second center tube 370 is forced away from the first end plate 350. In this situation, the spring tube bypass assembly is in an open state and fluid may flow through the bypass fluid openings 390 and directly to the interior of the second center tube 370 without passing through the filter media 320.

The spring 330 is located between the first center tube 380 and the second center tube 370. The spring 330 may be any appropriate spring. In one embodiment, the spring 330 is a coil spring with a diameter substantially the same as the first and second spring support flanges 387, 376.

The second end plate 340 includes fluid outlet 315. The sizes of the components of the spring tube bypass assembly are such that the components are not capable of passing through the fluid outlet 315. This relationship prevents components of the spring tube bypass assembly from flowing out of the filter cartridge 310 and reaching downstream elements. Damage may occur to downstream elements if components of the spring tube bypass assembly reach downstream components, resulting in downtime or repair costs. By preventing downstream damage as a result of spring tube bypass components, manufacturer warranty costs, repair costs and downtime may be minimized.

The spring tube bypass assembly allows for a much lower pressure gradient across the valve in comparison to pre-existing bypass valves. In one comparative example, the pressure drop across a pre-existing bypass valve may be 435 kPa at an equilibrium valve lift of 2.8 mm. The equilibrium valve lift is the point at which the fluid forces acting on the valve and the spring forces acting on the valve are equivalent. Under the same conditions, the spring tube bypass valve exhibits a pressure drop of 250 kPa at an equilibrium valve lift of 0.8 mm. The reduced pressure gradient across the spring tube bypass assembly an reduced equilibrium valve lift are a significant advantage in comparison to pre-existing bypass valve assemblies.

The center tubes of the spring tube bypass assembly may be cylindrical and have fluid flow openings defined by a plurality of ribs. The fluid flow openings allow fluid that has passed through the filter media to enter the interior of the center tube and then pass out of the filter cartridge.

The spring tube bypass assembly exhibits an increased resistance to buckling when acted on by external pressure in comparison to pre-existing center tube designs. The thickness of the walls of the center tubes of the spring tube bypass assembly may be greater than thickness of the walls of pre-existing center tubes. A center tube assembly of the spring tube bypass assembly with a wall thickness tapering from 5.5 mm to 3 mm exhibits the onset of buckling at an external pressure of 8 Bar. By comparison, a pre-existing center tube with a wall thickness of 1.59 mm exhibited buckling at an external pressure of 4.53 Bar under the same conditions. The increased resistance to buckling exhibited by the spring tube bypass assembly improves the reliability of the filter cartridge.

As utilized herein, the terms “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It is important to note that the construction and arrangement of the various embodiments are illustrative only. Although only a few embodiments have been described in detail in this disclosure, those skilled in the art who review this disclosure will readily appreciate that many modifications are possible (e.g., variations in structures, shapes and proportions of the various elements, values of parameters, mounting arrangements, use of materials, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various embodiments without departing from the scope of the present invention.

1. A filter cartridge comprising:
filter media,
a first end plate including a bypass flow opening,
a second end plate, and
a spring tube bypass assembly including a first center tube, a spring, and at least one fluid flow opening configured to receive fluid that flows through the bypass flow opening,
wherein the spring tube bypass assembly is configured such that fluid flow through the bypass flow opening is blocked when a fluid pressure acting on the filter cartridge is below a predetermined pressure, and fluid may flow through the bypass flow opening when the fluid pressure acting on the filter cartridge exceeds the predetermined pressure.

2. The filter cartridge of claim 1, wherein the second end plate includes a fluid outlet, and all of the components of the spring tube bypass assembly have a size exceeding the size of the fluid outlet, such that the components of the spring tube bypass assembly cannot pass through the fluid outlet.

3. The filter cartridge of claim 1, wherein the spring tube bypass assembly further includes a second center tube.

4. The filter cartridge of claim 3, wherein the spring, the first center tube, and the second center tube extend along a longitudinal axis of the filter cartridge.

5. The filter cartridge of claim 3, wherein the first center tube and the second center tube are attached to each other.

6. The filter cartridge of claim 5, wherein the first center tube and the second center tube are attached by a threaded attachment or an adhesive bond.

7. The filter cartridge of claim 3, wherein the spring is disposed within the first center tube and the second center tube.

8. The filter cartridge of claim 3, wherein the first center tube includes a first spring support flange extending radially on the interior of the first center tube, such that the spring bears against the first spring support flange, and wherein the second center tube includes a second spring support flange extending radially on the interior of the second center tube, such that the spring bears against the second spring support flange.

9. The filter cartridge of claim 8, wherein the second spring support flange includes the at least one fluid flow opening.

10. The filter cartridge of claim 9, further comprising a valve element disposed between the spring and the second spring support flange, the valve element configured to prevent flow from the at least one fluid flow opening to an interior of the second center tube when the fluid pressure acting on the filter cartridge is below the predetermined pressure.

11. The filter cartridge of claim 10, wherein the valve element includes a channel configured to locate the valve element with respect to the spring.

12. The filter cartridge of claim 8, wherein the spring is disposed between the first center tube and the second center tube.

13. The filter cartridge of claim 8, wherein an end of the second center tube adjacent the first end plate is configured to prevent flow from the bypass flow opening to the interior of the second center tube when the fluid pressure acting on the filter cartridge is below the predetermined pressure.

14. The filter cartridge of claim 3, wherein the second center tube is attached to the first end plate.

15. The filter cartridge of claim 14, wherein the second center tube is embedded in the first end plate or the second center tube is attached to the first end plate by a press-fit attachment or an adhesive bond.

16. The filter cartridge of claim 1, wherein the first center tube includes a first spring support flange extending radially on the interior of the first center tube, such that the spring bears against the first spring support flange.

17. The filter cartridge of claim 16, further comprising a valve element disposed between the spring and the first end plate, the valve element configured to prevent flow from the bypass flow opening to the interior of the first center tube when the fluid pressure acting on the filter cartridge is below the predetermined pressure.

18. The filter cartridge of claim 17, wherein the valve element includes a channel configured to locate the valve element with respect to the spring.

19. The filter cartridge of claim 1, wherein the first center tube is attached to the second end plate.

20. The filter cartridge of claim 1, wherein the spring is disposed in an interior cavity of the first center tube.

21. The filter cartridge of claim 1, wherein the filter cartridge is configured such that the spring tube bypass assembly extends along a central axis of the filter cartridge between the first end plate and the second end plate.

22. The filter cartridge of claim 1, wherein the filter cartridge is configured such that when the fluid pressure acting on the filter cartridge is below the predetermined pressure, all fluid flows through the filter media before passing in to an interior of the first center tube.

23. The filter cartridge of claim 1, wherein the spring does not contact the filter media.

24. The filter cartridge of claim 1, wherein the first end plate further comprises a plurality of projections configured to locate the spring tube bypass assembly relative to the first end plate.
